(19) United States
(12) Patent Application Publication
(10) Pub. No.: US 2026/0127171 A1
(43) Pub. Date: May 7, 2026

(54) ZERO-SHOT TUNING FOR LARGE-SCALE DATA PROCESSING QUERIES

(71) Applicant: THE TORONTO-DOMINION BANK, TORONTO (CA)

(72) Inventors: Raunaq Suri, Mississauga (CA); Ilan Gofman, TORONTO (CA); Guangwei Yu, TORONTO (CA); Jesse Cole Cresswell, TORONTO (CA); Maksims Volkovs, TORONTO (CA)

(21) Appl. No.: 19/245,637

(22) Filed: Jun. 23, 2025

Related U.S. Application Data
(60) Provisional application No. 63/715,095, filed on Nov. 1, 2024.

(51) Int. Cl. G06F 16/2453

(52) U.S. Cl. CPC G06F 16/24542

(57) ABSTRACT

A configuration system generates operational computing configurations for data processing queries, such as computer model and artificial intelligence training and inference, using historic execution plans to determine suitable parameter values for the computing configuration. By using historic execution plans to determine an operational computing configuration, the configuration system avoids computationally expensive conventional methods for optimizing data processing queries by instead using zero-shot or “offline” tuning. The configuration system uses embedding representations of execution plans to identify historic execution plans that are similar to an execution plan for a new query. Based on the optimized execution configurations of the similar historic execution plans, the configuration system determines an operational computing configuration for the execution plan for the new query.

### CROSS-REFERENCE TO RELATED APPLICATIONS

This application claims the benefit of U.S. Provisional Application No. 63/715,095, filed Nov. 1, 2024, the contents of which are incorporated by reference in its entirety.

### BACKGROUND

This disclosure relates generally to data processing, and more specifically to a system for optimizing execution of data queries.

Data processing systems for managing large-scale data processing may be used in a variety of applications and industries, such as in training or applying machine learning models, artificial intelligence applications, processing of large data sets, and the like. As data sets become larger or more complex, queries to the data sets also become more computationally complex. Rather than execute the query directly, an execution plan may be developed for received queries to optimize the processing steps for executing a query effectively. Execution plans may break down queries into a set of logical processing steps, such that various steps or groups of steps within a query may be executed in parallel across clusters of machines. Execution plans may be optimized for, variously, resource allocation, memory management, execution strategies, execution time, and so on.

Execution plans may have hundreds of tunable parameters impacting performance. Optimization of these parameters ensures that queries are run for efficient resource utilization in distributed processing. Poor configuration parameter selection can result in under-utilization of system resources, or worse, over-commitment resulting in application failures. Conventionally, parameter optimization is tuned to the specific job being run. However, most common methods for parameter optimization rely on online tuning methods, such as Bayesian Optimization (BO) techniques. These tuning methods iteratively run execution plans for observation of runtime characteristics and update parameters for each subsequent run based on the runtime observations until optimal parameters are determined. For large data sets and complex queries, this iterative processing is often computationally expensive and may be infeasible or prohibitive, particularly for ad hoc queries that are intended to be run only once or infrequently. Because of the large number of potential processing steps and configuration settings for an execution plan, it is difficult to directly determine relevant configuration settings to use in zero-shot tuning.

### SUMMARY

A configuration system uses optimized historic execution plans to generate configuration parameters for execution plans for new queries using zero-shot tuning. Zero-shot tuning, where parameters of execution plans are automatically set before an initial run of the execution plan, can provide significant computational savings for data processing systems, but may be more difficult than conventional methods of online tuning, as runtime information for the specific query is not available.

Configuration systems with access to historic information about previously executed and optimized execution plans, however, may determine an operational execution configuration for an execution plan based on optimized execution configurations for other, similar execution plans. By determining what execution plans are similar and how to determine parameters for the operational execution configuration from the similar plans, the configuration system enables data processing systems to execute the corresponding query more effectively (e.g., with faster execution time, improved memory usage, etc.) and without relying on unoptimized (e.g., default) parameters.

In various embodiments, the configuration system identifies similar execution plans based on embeddings representative of the execution plans. In some embodiments, the embeddings are vector representations of the execution plans, such that an embedding for the execution plan may be directly compared by the configuration system to embeddings corresponding to stored historic execution plans. When similar historic execution plans are identified, the configuration system retrieves the set of optimized execution configurations for the identified similar historic execution plans. For example, the configuration system may retrieve a top-k set of similar historic execution plans and their corresponding optimized execution configurations.

The configuration system determines the operational computing configuration for the execution plan based on the optimized execution configurations corresponding to the similar historic execution plans. In various embodiments, the configuration system may calculate mean configuration values of the optimized execution configurations and apply the mean configuration values to the operational computing configuration. The configuration system thus enables the data processing system to run the execution plan with the operational execution configuration rather than a default parameter configuration, bypassing the necessity for iteratively running the query to determine a tuned parameter configuration.

### BRIEF DESCRIPTION OF THE DRAWINGS

FIG. 1 illustrates an example environment for a data processing system including a configuration system, according to one embodiment.

FIG. 2 is an example block diagram of a configuration system, according to one embodiment.

FIG. 3 is an example timing diagram for generating operational computing configurations for queries, according to one embodiment.

FIG. 4 illustrates example graphs describing a set of tunable parameters for historic execution plans.

FIG. 5 is an example flowchart for generating an operational computing configuration for a query, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

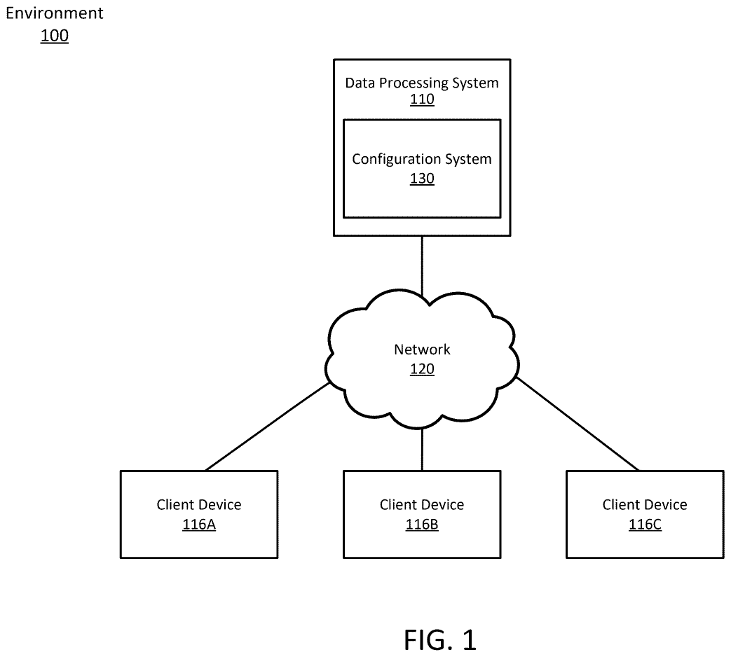

FIG. 1 illustrates an example environment 100 for a data processing system 110 including a configuration system 130, according to one embodiment. The data processing system 110 manages data by executing various data processing queries received from one or more client devices 116 via a network 120. When data processing queries are received for execution, the configuration system 130 provides an execution configuration specifying parameter values for one or more logical processing steps of the data processing queries. The network 120 provides a communication channel between the data processing system 110 and the client devices 116. In other embodiments, different and/or additional components may be included in the system environment 100, and one or more components may perform different functions.

In the embodiment of FIG. 1, the data processing system 110 stores or accesses data for one or more client devices 116, and may manage data processing for a variety of applications and industries having various processing needs. As the data processing system 110 interacts with increasingly large or complex data sets, such as processing training data and output data of machine learning models or other large data sets, queries executed by the data processing system likewise become computationally complex. Often, data processing systems 110 use execution plans to better execute received queries rather than executing the queries directly. Data processing systems 110 generate execution plans to represent logical processing steps of queries. The logical processing steps may include, for example, retrieval of data sets from data tables, parsing, aggregating, or filtering data, transforming data, e.g., by applying one or more machine learning models or other operations, and so on. The data processing system 110 may distribute some or all of the logical processing steps of an execution plan to be executed across discrete computing machines (e.g., at one or more machine clusters), enabling individual logical processing steps (or sets of logical processing steps) to be optimized for relevant resources, memory, or timing requirements.

Execution of particular execution plans uses a large number (e.g., hundreds, thousands) of tunable parameters describing how the plan is executed by the computing systems. These tunable parameters impact performance during execution, specifying resource requirements and allocation, memory usage, and so on. The data processing system 110 uses a configuration system 130 to determine computing configurations that specify operational values of parameters for execution plans. As shown in the example of FIG. 1, the configuration system 130 may be a part of the data processing system 110. In other examples, the configuration system 130 may be communicatively coupled to the data processing system 110 via the network 120.

In some embodiments, the data processing system 110 uses Apache Spark or another similar distributed data processing environment to run execution plans. Apache Spark and similar distributed data processing environments may use a central driver program to orchestrate execution of received queries and a plurality of distributed executor processes which run on worker nodes to execute assigned tasks. In particular, the central driver program may convert received queries into execution plans including a series of logical processing steps, assign and schedule logical processing steps within the execution plans to be executed on specific executors, and monitor task execution. The driver program ensures that resources are correctly allocated to executors to enable executors to execute assigned logical processing steps or sets of logical processing steps and that logical processing steps have sufficiently tuned parameters so as not to overburden computing nodes and are allocated to appropriate executors.

Resources of distributed data processing environments such as Apache Spark may be allocated based on various application requirements. When logical processing steps of execution plans are executed concurrently, the same resources may be required by multiple computing nodes of the distributed data processing environment. While a driver program may isolate or schedule logical processing steps to reduce resource contention, it may also be necessary to distribute resources based on requirements of particular logical processing steps. Variously, logical processing steps may be associated with configuration parameters which may be tuned (or optimized) by using appropriate data formats, optimizing data partitioning, using appropriate caching and persisting, reducing shuffle size, configuring memory and parallelism, using built-in functions and operations over user-defined functions, and monitoring and tuning for resource usage during runtime of logical processing steps. Poorly selected configuration parameters for execution plans can result in subsequently poor performance during execution, resulting in under-or over-utilization of system resources, causing slow or inefficient application runtime relative to “optimal” performance. However, optimization of configuration parameters in conventional configuration systems requires iteratively running execution plans to observe runtime characteristics until optimal parameters are determined. For large data sets and complex queries, iterative processing of this nature is often computationally expensive and, particularly for ad hoc queries intended to be run only once or infrequently, may be infeasible or prohibitive.

The configuration system 130 uses optimized historic execution plans to generate operational configuration parameters for new execution plans using zero-shot tuning. In zero-shot tuning, operational configuration parameters for execution plans are automatically set before an initial run of the execution plan. For these types of execution plans that are not iteratively run, zero-shot tuning can provide significant computational savings for the data processing system 110. However, the operational configuration parameters for these execution plans must be determined without runtime characteristics for the specific query and its associated execution plan.

The configuration system 130 uses historic information about previously executed and optimized execution plans to determine an operational computing configuration. Given a sufficiently large set of optimized “similar” execution plans, the configuration system 130 may generate an operational configuration parameter for a new execution plan (not previously executed) based on parameter values for corresponding parameters from the similar execution plans. The parameters values determined for the similar historic plans may then be analyzed to determine a parameter value for the current plan, for example with statistical analysis of the values for the prior plan. The parameter value for the current plan may be set as a mean or mode of the similar plan values, may exclude outlier values of similar plans and so forth. For queries intended to be executed only once or infrequently by the data processing system 110, these non-default operational configuration parameters provide improved execution performance and efficiency in comparison to optimizing an execution plan using a more conventional iterative method or to using default, unoptimized parameters.

In various embodiments, the operational configuration parameters may be used as a starting point for later optimization for execution plans. Alternately, the operational configuration parameters may be a “one-time” set of parameters which the configuration system 130 transmits to the data processing system 110 so that the execution query can be run using the operational configuration parameters without further optimization. As such, the operational configuration parameters based on identifying similar execution plans may be used for an initial query execution rather than default configurations. When the query is subsequently executed additional times, the parameters for those executions may then be further optimized.

In various embodiments, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

Client devices 116 may be any suitable client device for transmitting and receiving data via the network 120. As examples, client devices 116 may be a desktop or laptop computer or server terminal as well as mobile devices, touchscreen displays, or other types of devices which can exchange data with the data processing system 110.

Client devices 116 transmit queries to the data processing system 110 to be applied to stored data and receive query responses. Queries may request portions of stored data relevant to one or more downstream processes, such as outputs of a trained computer model stored by the data processing system 110, which may be applied to inform decisions or to be further processed in one or more downstream processes, or may request additions, modifications, or deletions to be made to portions of stored data. Queries by client devices 116 may additionally request other information about data of the data processing system 110, such as, for example, for metadata describing data of the data processing system, audit or validation information, and the like.

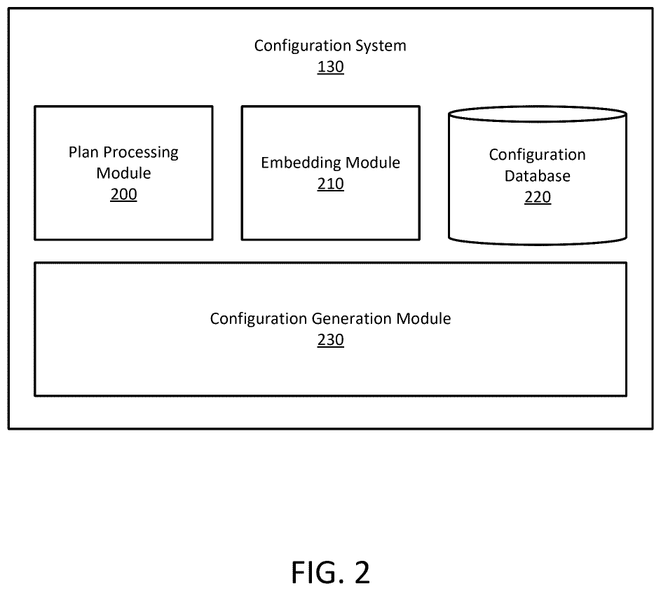

FIG. 2 is an example block diagram of a configuration system 130, according to one embodiment. The configuration system 130 comprises a plan processing module 200, an embedding module 210, a configuration database 220, and a configuration generation module 230. In other embodiments, different and/or additional components may be included in the configuration system 130, and one or more components of the configuration system 130 may instead be included in the data processing system 110.

The plan processing module 200 receives execution plans from one or more data processing systems 110 and, based on the received execution plans, determines similar historic execution plans with optimized configuration parameters for generating operational configuration parameters for the received execution plans. In various embodiments, the plan processing module 200 may communicate via a network, such as the network 120 of FIG. 1, to receive execution plans for queries from data processing systems 110. In other embodiments, the plan processing module 200 may receive queries from data processing systems 110, which must be converted to execution plans by the plan processing module 200. Execution plans are associated with one or more logical processing steps, each logical processing step additionally including one or more tunable parameters.

Upon receipt of an execution plan, the plan processing module 200 passes the received execution plan to the embedding module 210. The embedding module 210 generates embeddings representing execution plans by applying an embedding model to received execution plans. The embedding model is configured to receive an execution plan as input and to output a vector representation of the received execution plan in an embedding space. For example, the embedding model may be a large language model (LLM) pre-trained or fine-tuned on historic execution plans. In some instances, the execution plans may be represented (or converted) as one or more tokens processable by the LLM to generate an embedding representation of the execution plan. For example, the execution plan may describe individual processing steps as a data structure (e.g., a directed acyclic graph) that can be sequenced for ingestion by the LLM as a set of tokens describing the steps and relationship between them. In other examples, the embedding model may be any other suitable machine learning model, such as an encoder portion of an autoencoder trained on execution plans.

The plan processing module 200 accesses the configuration database 220 to compare the embedding for the received execution plan to one or more historic execution plans. The configuration database 220 stores each historic execution plan in association with an embedding representative of the respective historic execution plan. The embedding may be, for example, vector representations of the respective historic execution plan output by the embedding model of the embedding module 210.

Historic execution plans stored in the configuration database 220 are associated with respective logical processing steps and configuration parameters for the logical processing steps. In various embodiments, historic execution plans stored in the configuration database 220 may have associated configurated parameters that were optimized via various methods (e.g., conventional iterative optimization methods), such that each historic execution plan is associated with a set of optimized configuration parameters. In other embodiments, historic execution plans stored in the configuration database 220 may be associated with at least one set of operational configuration parameters, such that the configuration parameters are more efficient or produce higher performance for that historic execution plan during runtime than default configuration parameters.

The plan processing module 200 identifies, from the configuration database 220, a set of similar execution plan embeddings for historic execution plans. Similarity between vector embeddings may be determined based on a Euclidian distance between the embedding for the received execution plan and a respective embedding for a historic execution plan. In some embodiments, the plan processing module 200 evaluates similarity of embeddings by calculating a cosine similarity between the embedding for the received execution plan and one or more embeddings of historic execution plans. Other methods of measuring similarity between the embeddings may also be used.

The plan processing module 200 retrieves a set of optimized execution configurations for the historic execution plans associated with the identified set of similar embeddings. The plan processing module 200 may retrieve, for example, a top-k set of similar execution plan embeddings by identifying a number k of embeddings of historic execution plans with highest similarity scores to the embedding for the received execution plan, wherein k may be manually determined by an administrator or user or may be determined empirically by the plan processing module. The plan processing module 200 retrieves the set of optimized execution configurations corresponding to the identified set of similar embeddings. The retrieved set of optimized execution configurations are transmitted to the configuration generation module 230.

The configuration generation module 230 generates an operational computing configuration based on the retrieved historic execution plans and corresponding configurations. In some embodiments, the configuration generation module 230 may evaluate the retrieved set of optimized execution configurations for historic execution plans to determine whether configuration values within the set of optimized execution configurations are within a threshold similarity. In cases where one or more configuration values of the retrieved set of optimized execution configurations substantially differ within a given parameter, the configuration generation module 230 may exclude the optimized execution configuration associated with the substantially different configuration value, or may request from the plan processing module 200 an additional set of optimized execution configurations (e.g., a next set of similar execution plan embeddings and corresponding optimized execution configurations).

In various embodiments, the configuration generation module 230 generates an operational computing configuration based on the respective configuration values for one or more parameters of the set of historic execution plans. For each particular operational parameter, the value of the parameter in the similar execution plans may be analyzed to determine the value for the current operational computing configuration. The value may be determined by various means, including statistical analysis of the similar plans, which may include identifying and excluding outlier values. As such, the value of the parameter may be a mean, weighted mean (e.g., weighed based on embedding distance), a mode, and other statistical evaluations of the values associated with the optimized parameters of the similar plans. As one example, the configuration generation module 230 determines, for each parameter of the received execution plan, a mean configuration value corresponding to the respective parameter for the set of historic execution plans. For similar execution plans, the mean configuration value for the set of historic execution plans is more likely than default parameter values to improve runtime performance of the received execution plan, being a representative configuration value for similar execution plans.

The configuration generation module 230 combines the determined configuration values (for the respective parameters) into an operational computing configuration. The operational computing configuration may be transmitted to the data processing system 110, such that the received execution plan may be run by the data processing system using the updated parameters. Although computing configurations determined in this manner are not determined based on the specific runtime characteristics for the received execution plan, the use of similar historic execution plans to determine operational values for parameters ensures that the operational computing configurations perform more efficiently than default parameter values. By identifying similar plans based on vector representations within an embedding space, similar historic execution plans can reliably represent functional or intrinsic characteristics of an execution plan without requiring iterative execution.

### Generating Operational Execution Configurations for Queries

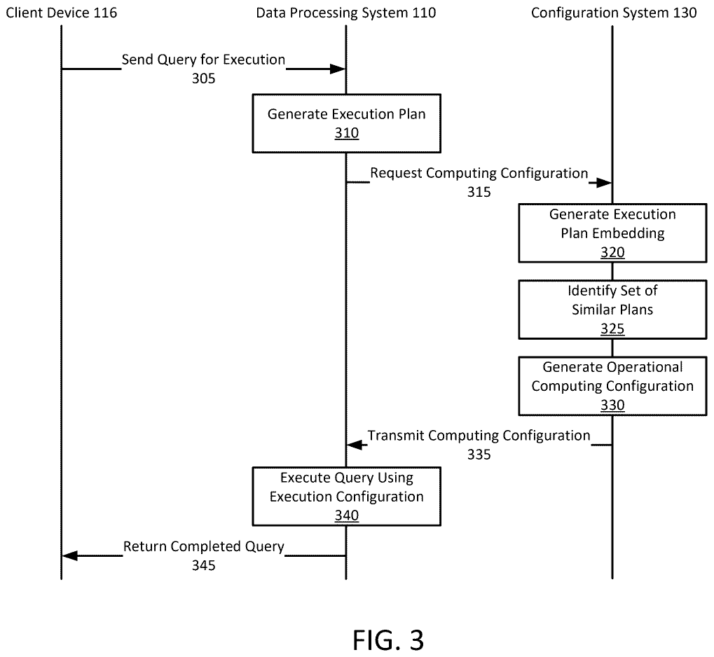

FIG. 3 is an example timing diagram for generating operational computing configurations for queries, according to one embodiment. A client device 116 sends 305 a query for execution to a data processing system 110. The query may include one or more query parameters for data to be retrieved, such as relevant data tables, data record identifiers (e.g., one or more keys), conditions, timestamps for data generation and/or storage, identifiers associated with the data, or the like, as well as one or more processes or operations to be applied to the data.

Based on the specifications of the received query, the data processing system 110 generates 310 an execution plan for executing the query. The execution plan characterizes the query into distinct logical processing steps, such that various steps or groups of steps within more complex queries may be executed in parallel across clusters of machines. This allows each logical processing step (or groups of logical processing steps) to be optimized independently for specific machines. Execution plans may include distinct logical processing steps including, for example, retrieval of data sets from data tables, parsing or aggregating data, transforming data, e.g., by applying one or more machine learning models or other operations, and so on. Each of these logical processing steps may be associated with different parameters for resource allocation, memory management, execution strategies, execution time, etc., wherein values selected for these parameters may impact the overall efficiency or accuracy of execution for the logical processing steps and subsequently for the execution plan as a whole.

The execution plan may have hundreds of parameters, which may be tuned to improve runtime performance. For each received execution plan, the data processing system 110 requests 315 a computing configuration for the execution plan from the configuration system 130. The computing configuration specifies a set of operational values for parameters of the execution plan.

In various embodiments, the configuration system 130 maintains or accesses a configuration database including a plurality of historic execution plans, where each historic execution plan is associated with a respective execution configuration. Historic execution plans may have been previously optimized, e.g., using conventional methods for tuning parameters of the execution plan across multiple runs or executions of the execution plan, or may be associated with operational computing configurations previously determined by the configuration system 130. Each historic execution plan is associated with an embedding representative of the historic execution plan.

Responsive to receiving a request for a computing configuration, the configuration system 130 generates 320 an execution plan embedding for the execution plan. In various embodiments, the configuration system 130 applies an embedding model to the execution plan, the embedding model being any machine learning model configured to convert an execution plan into a vector in an embedding space. For example, the embedding model may be a pre-trained or fine-tuned large language model (LLM) which is applied to execution plans by the configuration system 130 to output a vector embedding. In other examples, the configuration system 130 may use other machine learning models or processes for generating a standardized embedding for execution plans such that they can be compared in an embedding space to other embeddings for historic execution plans.

Based on the generated embedding, the configuration system 130 identifies 325 a set of similar execution plans from the plurality of historic execution plans. In various embodiments, the configuration system 130 selects a top-k set of similar execution plan embeddings and corresponding execution configurations. The most similar execution plan embeddings may be selected based on, for example, a cosine similarity to the embedding of the received execution plan.

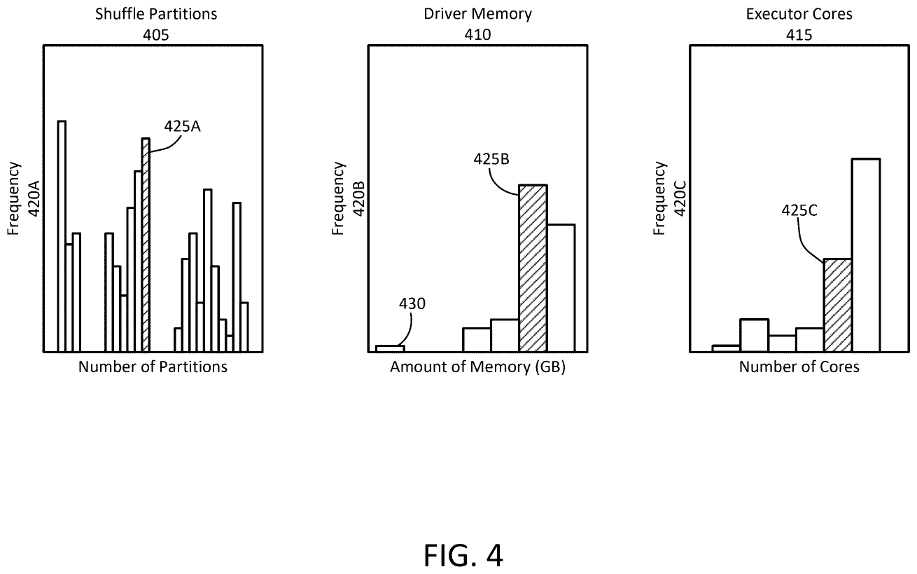

The configuration system 130 uses the set of historic execution plans to generate 330 an operational computing configuration for the received execution plan. FIG. 4 illustrates example graphs describing a set of tunable parameters for historic execution plans. As shown in FIG. 4, parameters for a logical processing step may specify a number of partitions 405, an amount of driver memory 410, and a number of executor cores 415 allocated to a processing step. In other examples, parameters for logical processing step may further specify a number of executors, a number of driver cores, an amount of executor memory, and so forth. The data processing system 110 may rely on these parameters to determine how and which machines are allocated to execute each logical processing step, as well as to determine dependencies within an execution plan.

For each parameter of the set of historic execution plans, the configuration system 130 identifies a frequency 420A-C of configuration values. Among the set of historic execution plans that are similar to a received execution plan, the configuration system 130 may determine a configuration value representative of the set of historic execution plans, and thus likely to be a suitable operational execution configuration for the received execution plan.

The configuration system 130 may calculate, for example, mean or average configuration values 425A-C for each parameter of the set of historic execution plans. Alternately, the configuration system may otherwise determine a configuration value represented among the set of historic execution plans as likely to be operational for the received execution plan, e.g., a configuration value associated with favorable or desirable runtime characteristics for a corresponding historic execution plan.

The configuration system 130 may evaluate a similarity between parameter values of the historic execution plans. This ensures that outlier values or sets of outlier values, such as the outlier 430 shown in FIG. 4, do not skew the mean configuration value 425 for the parameter. In some embodiments, outliers 430 beyond a certain threshold may be excluded from configuration value 425 calculations. In other embodiments, the configuration system 130 may identify and retrieve additional similar historic execution plans if a calculated value is not appropriately representative of the set of historic execution plans, wherein the additional similar historic execution plans may be included in configuration value 425 calculations to reach a representative value.

Based on the calculated configuration values 425 for each parameter, the configuration system 130 generates an operational computing configuration, wherein each parameter for the received execution plan is set to the corresponding configuration value determined from the historic execution plans. Returning to FIG. 3, the configuration system 130 transmits 335 the computing configuration including the determined parameter values to the data processing system 110, which executes 340 the received query according to the execution plan with the operational computing configuration. Once execution of the query is completed, the data processing system 110 returns 345 the completed query to the client device 116.

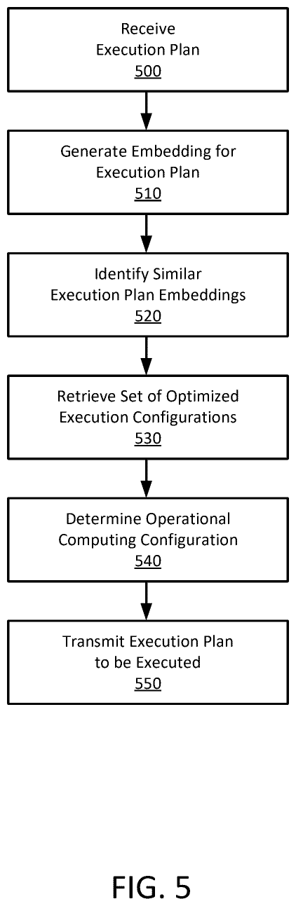

FIG. 5 is an example flowchart for generating an operational computing configuration for a query, according to one embodiment. A configuration system, such as the configuration system 130, receives 500 an execution plan from a data processing system 110. The execution plan includes one or more logical processing steps, each logical processing step associated with a set of tunable parameters. Each parameter may specify, for example, resource allocation, memory management, execution strategies, or execution time for a respective logical processing step, as well as dependencies between logical processing steps that may impact the efficiency or accuracy of the logical processing step being executed.

The configuration system 130 generates 510 an embedding for the received execution plan by applying an embedding model. In various embodiments, the embedding model may be a large language model (LLM) or other machine learning model configured to receive the execution plan as input and to generate a vector representation of the execution plan as output.

The embedding enables the configuration system 130 to compare the received execution plan with other embeddings of other execution plans to determine similarities between the received execution plan and other execution plans.

The configuration system 130 identifies 520 a set of similar execution plan embeddings of historic execution plans. For example, the configuration system 130 calculates a cosine similarity between the embedding of the received execution plan and embeddings for each historic execution plan and identifies a set of most similar historic execution plan embeddings based on the cosine similarity scores. Each historic execution plan is associated with an execution configuration. In various embodiments, the execution configurations associated with the historic execution plans are optimized for execution.

The configuration system 130 retrieves 530 a set of optimized execution configurations associated with the set of similar execution plan embeddings. Based on the optimized execution configurations, the configuration system 130 determines 540 an operational computing configuration for the received execution plan. The configuration system 130 may calculate, for each parameter of the optimized execution configurations, a mean configuration value, or may otherwise determine a representative value for each parameter. The operational computing configuration is thus determined 540 to be the set of representative configuration values for the relevant parameters of the received execution plan, which is then transmitted 550 by the configuration system 130 to the data processing system 110 for execution.

### Conclusion

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for configuration of an execution plan for data query, comprising:
one or more processors; and
a non-transitory computer-readable medium having instructions executable by the one or more processors for:
receiving the execution plan, the execution plan characterizing one or more logical processing steps for executing a query;
generating an execution plan embedding for the execution plan, the execution plan embedding being a vector representation of the execution plan;
identifying a set of similar execution plan embeddings for historic execution plans from a set of historic execution plan embeddings;
retrieving a set of optimized execution configurations for the historic execution plans associated with the set of similar execution plan embeddings;
determining an operational computing configuration for the execution plan based on the retrieved set of associated configurations; and
transmitting the operational computing configuration for executing the execution plan with the operational computing configuration.

2. The system of claim 1, wherein generating an embedding for the execution plan further comprises applying a large language model (LLM) to the execution plan.

3. The system of claim 1, wherein determining an operational computing configuration for the execution plan further comprises determining mean configuration values of one or more parameters of the set of historic execution plans.

4. The system of claim 1, wherein identifying a set of similar execution plan embeddings for historic execution plans further comprises selecting one or more of the similar execution plan embeddings based on a cosine similarity to the vector representation of the execution plan.

5. The system of claim 1, wherein retrieving a set of optimized execution configurations for the historic execution plans associated with the set of similar execution plan embeddings further comprises retrieving a top-k set of similar execution plan embeddings and corresponding optimized execution configurations.

6. The system of claim 1, wherein retrieving a set of optimized execution configurations for the historic execution plans associated with the set of similar execution plan embeddings further comprises:
retrieving a first plurality of optimized execution configurations;
determining that one or more configuration values of the first plurality of optimized execution configurations substantially differ from other configuration values
within the first plurality of optimized execution configurations; and
retrieving an additional plurality of optimized execution configurations.

7. The system of claim 1, wherein the execution plan includes steps for applying a computer model.

8. The system of claim 1, wherein the historic execution plans are optimized by repeated execution of queries and the execution plan is a one-time operational computing configuration.

9. A method for configuration of an execution plan for data query, comprising:
receiving the execution plan, the execution plan characterizing one or more logical processing steps for executing a query;
generating an execution plan embedding for the execution plan, the execution plan embedding being a vector representation of the execution plan;
identifying a set of similar execution plan embeddings for historic execution plans from a set of historic execution plan embeddings;
retrieving a set of optimized execution configurations for the historic execution plans associated with the set of similar execution plan embeddings;
determining an operational computing configuration for the execution plan based on the retrieved set of associated configurations; and
transmitting the operational computing configuration for executing the execution plan with the operational computing configuration.

10. The method of claim 9, wherein generating an embedding for the execution plan further comprises applying a large language model (LLM) to the execution plan.

11. The method of claim 9, wherein determining an operational computing configuration for the execution plan further comprises determining mean configuration values of one or more parameters of the set of historic execution plans.

12. The method of claim 9, wherein identifying a set of similar execution plan embeddings for historic execution plans further comprises selecting one or more of the similar execution plan embeddings based on a cosine similarity to the vector representation of the execution plan.

13. The method of claim 9, wherein retrieving a set of optimized execution configurations for the historic execution plans associated with the set of similar execution plan embeddings further comprises retrieving a top-k set of similar execution plan embeddings and corresponding optimized execution configurations.

14. The method of claim 9, wherein retrieving a set of optimized execution configurations for the historic execution plans associated with the set of similar execution plan embeddings further comprises:
retrieving a first plurality of optimized execution configurations;
determining that one or more configuration values of the first plurality of optimized execution configurations substantially differ from other configuration values within the first plurality of optimized execution configurations; and
retrieving an additional plurality of optimized execution configurations.

15. The method of claim 9, wherein the execution plan includes steps for applying a computer model.

16. The method of claim 9, wherein the historic execution plans are optimized by repeated execution of queries and the execution plan is a one-time operational computing configuration.

17. A non-transitory computer-readable medium for configuration of an execution plan for data query, the non-transitory computer-readable medium comprising instructions executable by a processor for:
generating an execution plan embedding for the execution plan, the execution plan embedding being a vector representation of the execution plan;
identifying a set of similar execution plan embeddings for historic execution plans from a set of historic execution plan embeddings;
retrieving a set of optimized execution configurations for the historic execution plans associated with the set of similar execution plan embeddings;
determining an operational computing configuration for the execution plan based on the retrieved set of associated configurations; and
transmitting the operational computing configuration for executing the execution plan with the operational computing configuration.

18. The non-transitory computer-readable medium of claim 17, wherein the instructions for generating an embedding for the execution plan are further executable for applying a large language model (LLM) to the execution plan.

19. The non-transitory computer-readable medium of claim 17, wherein the instructions for determining an operational computing configuration for the execution plan are further executable for determining mean configuration values of one or more parameters of the set of historic execution plans.

20. The non-transitory computer-readable medium of claim 17, wherein the instructions for identifying a set of similar execution plan embeddings for historic execution plans are further executable for selecting one or more of the similar execution plan embeddings based on a cosine similarity to the vector representation of the execution plan.
